(19) United States
(12) Patent Application Publication
(10) Pub. No.: US 2017/0270406 A1
(43) Pub. Date: Sep. 21, 2017

(54) CLOUD-BASED PROCESSING USING LOCAL DEVICE PROVIDED SENSOR DATA AND LABELS

(71) Applicant: QUALCOMM Incorporated, San Diego, CA (US)

(72) Inventors: Erik VISSER, San Diego, CA (US); Minho JIN, San Jose, CA (US); Lae-Hoon KIM, San Diego, CA (US); Raghuveer PERI, Los Angeles, CA (US); Shuhua ZHANG, San Diego, CA (US)

(21) Appl. No.: 15/273,496

(22) Filed: Sep. 22, 2016

Related U.S. Application Data
(60) Provisional application No. 62/310,147, filed on Mar. 18, 2016.

(51) Int. Cl. G06N 3/08; G06N 3/04

(52) U.S. Cl. CPC G06N 3/08; G06N 3/04

(57) ABSTRACT

A method of training a device specific cloud-based audio processor includes receiving sensor data captured from multiple sensors at a local device. The method also includes receiving spatial information labels computed on the local device using local configuration information. The spatial information labels are associated with the captured sensor data. Lower layers of a first neural network are trained based on the spatial information labels and sensor data. The trained lower layers are incorporated into a second, larger neural network for audio classification. The second, larger neural network may be retrained using the trained lower layers of the first neural network.

### CROSS-REFERENCE TO RELATED APPLICATION

The present application claims the benefit of U.S. Provisional Patent Application No. 62/310,147, filed on Mar. 18, 2016 and titled “CLOUD-BASED PROCESSING USING LOCAL DEVICE PROVIDED SENSOR DATA AND LABELS,” the disclosure of which is expressly incorporated by reference herein in its entirety.

### BACKGROUND

Field

Certain aspects of the present disclosure generally relate to machine learning and, more particularly, to improving systems and methods of cloud-based processing using sensor data and labels of a local device.

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In an aspect of the present disclosure, a method of training a device specific cloud-based audio processor is presented. The method includes receiving sensor data captured from multiple sensors at a local device and receiving spatial information labels computed on the local device using local configuration information. The spatial information labels are associated with the captured sensor data. The method also includes training lower layers of a first neural network based on the spatial information labels and sensor data. Additionally, the method includes incorporating the trained lower layers into a second, larger neural network for audio classification. The method further includes retraining the second neural network using the trained lower layers of the first neural network.

In another aspect of the present disclosure, a method of cloud-based audio processing using an artificial neural network is presented. The method includes receiving device identification information of a local device and sensor data captured from multiple sensors at the local device. The method also includes setting convolutional filters of the neural network based on the device identification information. The method further includes predicting an audio event classification based on the sensor data without retraining the neural network.

In yet another aspect of the present disclosure, an apparatus for training a device specific cloud-based audio processor is presented. The apparatus includes a memory coupled to at least one processor. The one or more processors are configured to receive sensor data captured from multiple sensors at a local device and to receive spatial information labels computed on the local device using local configuration information. The spatial information labels are associated with the captured sensor data. The processor(s) is(are) also configured to train lower layers of a first neural network based on the spatial information labels and sensor data. Additionally, the processor(s) is(are) configured to incorporate the trained lower layers into a second, larger neural network for audio classification. The processor(s) is(are) further configured to retrain the second neural network using the trained lower layers of the first neural network.

In still another aspect of the present disclosure, an apparatus for cloud-based audio processing using an artificial neural network is presented. The apparatus includes a memory coupled to at least one processor. The one or more processors are configured to receive device identification information of a local device and sensor data captured from multiple sensors at the local device. The processor(s) is(are) also configured to set convolutional filters of the neural network based on the device identification information. The processor(s) is(are) further configured to predict an audio event classification based on the sensor data without retraining the neural network.

In an aspect of the present disclosure, an apparatus for training a device specific cloud-based audio processor is presented. The apparatus includes means for receiving sensor data captured from multiple sensors at a local device and means for receiving spatial information labels computed on the local device using local configuration information. The spatial information labels are associated with the captured sensor data. The apparatus also includes means for training lower layers of a first neural network based on the spatial information labels and sensor data. Additionally, the apparatus includes means for incorporating the trained lower layers into a second neural network for audio classification. The apparatus further includes means for retraining the second, larger neural network using the trained lower layers of the first neural network.

In another aspect of the present disclosure, an apparatus for cloud-based audio processing using an artificial neural network is presented. The apparatus includes means for receiving device identification information of a local device and sensor data captured from multiple sensors at the local device. The apparatus also includes means for setting convolutional filters of the neural network based on the device identification information. The apparatus further includes means for predicting an audio event classification based on the sensor data without retraining the neural network.

In yet another aspect of the present disclosure, a non-transitory computer readable medium is presented. The non-transitory computer readable medium has encoded thereon program code for training a device specific cloud-based audio processor. The program code is executed by a processor and includes program code to receive sensor data captured from multiple sensors at a local device and program code to receive spatial information labels computed on the local device using local configuration information. The spatial information labels are associated with the captured sensor data. The program code also includes program code to train lower layers of a first neural network based on the spatial information labels and sensor data. Additionally, the program code includes program code to incorporate the trained lower layers into a second neural network for audio classification. The program code further includes program code to retrain the second, larger neural network using the trained lower layers of the first neural network.

In still another aspect of the present disclosure, a non-transitory computer readable medium is presented. The non-transitory computer readable medium has encoded thereon program code for cloud-based audio processing using an artificial neural network. The program code is executed by a processor and includes program code to receive device identification information of a local device and sensor data captured from multiple sensors at the local device. The program code also includes program code to set convolutional filters of the neural network based on the device identification information. The program code further includes program code to predict an audio event classification based on the sensor data without retraining the neural network.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIGS. 6-8 are block diagrams illustrating cloud-based processing in accordance with aspects of the present disclosure.

FIGS. 9A-B are block diagrams illustrating training of the convolutional neural network in accordance with aspects of the present disclosure.

FIG. 10 illustrates an implementation using a recurrent neural network for processing on the cloud-based processor.

FIG. 11 illustrates a method for cloud-based audio processing using an artificial neural network in accordance with aspects of the present disclosure.

FIG. 12 illustrates a method for cloud-based multimedia processing in accordance with aspects of the present disclosure.

FIG. 13 illustrates a method for cloud-based audio processing using an artificial neural network in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Cloud-Based Processing Using Local Device Provided Sensor Data and Labels

Modern digital devices acquire a variety of sensor data and are able to communicate with a remote computing device, such as a cloud-based computing system or processor (which may be referred to as the “cloud”), for data analytics. The cloud, however, usually does not have the resources to compute relevant labels for the device-captured sensor data and thus the data cannot be used effectively in supervised classification tasks.

In circumstances where it is desirable to send a stream of data from devices with multiple inputs (e.g., cameras, microphones, or video feeds) to a server for processing, the sensor allocation and space-time information may be relevant. Thus, it may be useful to transmit such information with the raw sensor data.

Many smart phones, tablets, and other portable multimedia devices have multiple sensors (e.g., multiple microphones, multiple cameras, etc.) As such, a local device may, for example, encode sound in different formats (e.g., 5.1 format, 7.1 format, and stereo) because the placement of sensors on the local device is known. Local devices may also be configured to track sources (e.g., one or more speakers or other source of a sound captured by a microphone). For instance, a local device may be able to determine the direction of arrival (DOA) and may follow a source. Additionally, the local device may be configured to perform beamforming. That is, the local device may be configured to listen to sound originating from one direction in space and null out the sound originating from other directions. Many local devices can perform these tasks with low delay. However, when such multi-sensor data is sent to a cloud-based processor, it is very difficult to exploit the data efficiently and doing so is computationally expensive.

Aspects of the present disclosure are directed to cloud-based processing of sensor data and labels for a local device. Unlike conventional methods, which may use geotagging, in some aspects, multi-sensor data captured at a local device and local device provided labels may be supplied to a cloud-based processor for classification tasks using neural networks such as a convolutional neural network (CNN) or a long short-term memory recurrent neural network (LSTM-RNN). As opposed to geotagging, where geographic locations several 100 meters or kilometers away from each other are being tagged with coordinates using Global Positioning System (GPS) data, local device spatial sensor locations are within a room and all capture the same sound sources but with different amplitude/phase relationships between sensors. In accordance with aspects of the present disclosure, the multiple sensor information may be combined to provide enhanced spatial discrimination of sources (e.g., via beamforming) within a spatially confined location such as a room, concert hall or the like.

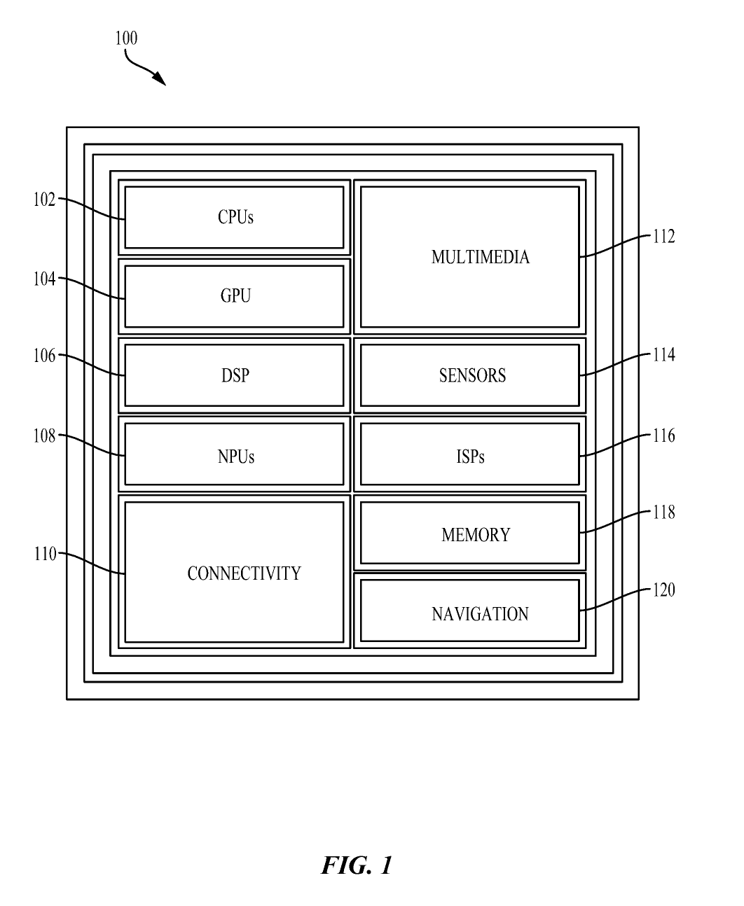

FIG. 1 illustrates an example implementation of the aforementioned cloud-based processing using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for receiving sensor data captured from multiple sensors at a local device. The instructions loaded into the general-purpose processor 102 may also comprise code for receiving spatial information labels computed on the local device using local configuration information. The labels are associated with the captured data. In addition, the instructions loaded into the general-purpose processor 102 may comprise code for training lower layers of a first neural network based on the spatial information labels and sensor data. Further, the instructions loaded into the general-purpose processor 102 may also comprise code for incorporating the trained lower layers into a second, larger neural network for audio classification. Furthermore, the instructions loaded into the general-purpose processor 102 may comprise code for retraining the larger neural network using the trained lower layers of the first neural network.

In another aspect of the present disclosure, the instructions loaded into the general-purpose processor 102 may comprise code for capturing sensor data and for computing labels using local configuration information. The labels are associated with the captured sensor data. The instructions loaded into the general-purpose processor 102 may also comprise code for sending the labels to a cloud-based processor. The instructions loaded into the general-purpose processor 102 may further comprise code for receiving classification results from the cloud and for performing tasks based on the classification results.

In yet another aspect of the present disclosure, the instructions loaded into the general-purpose processor 102 may comprise code for receiving device identification information of a local device and sensor data captured from multiple sensors at the local device. The instructions loaded into the general-purpose processor 102 may also comprise code for setting convolutional filters of the neural network based on the device identification information. The instructions loaded into the general-purpose processor 102 may further comprise code for predicting an audio event classification based on the sensor data without retraining the neural network.

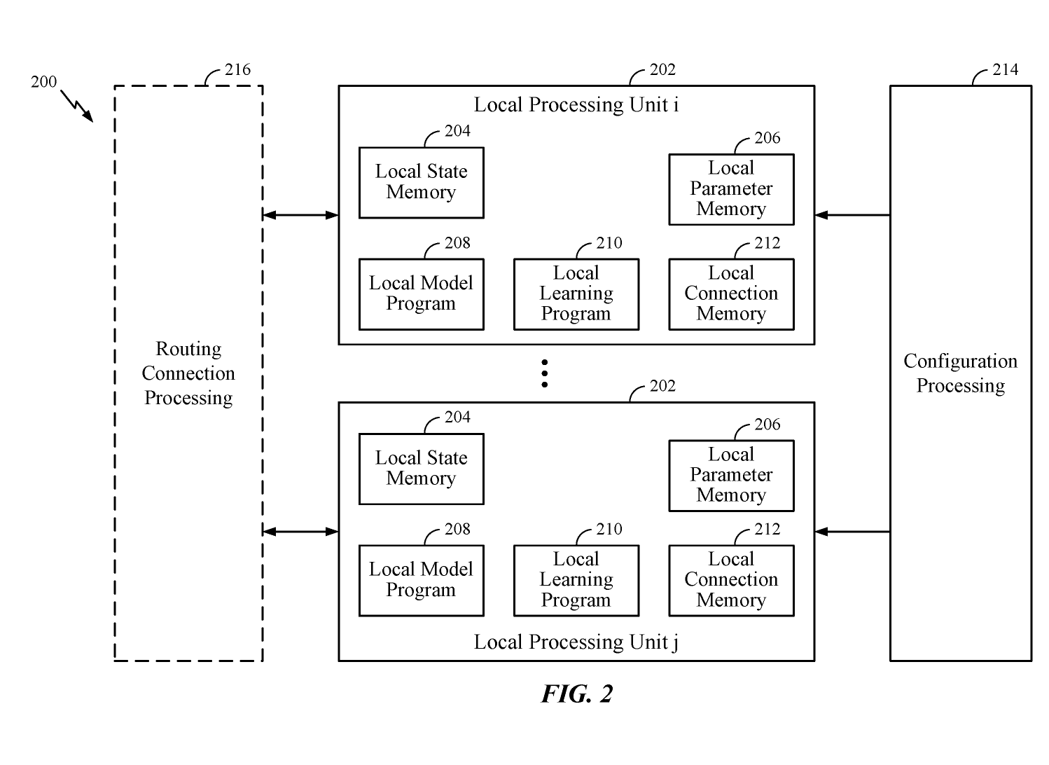

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

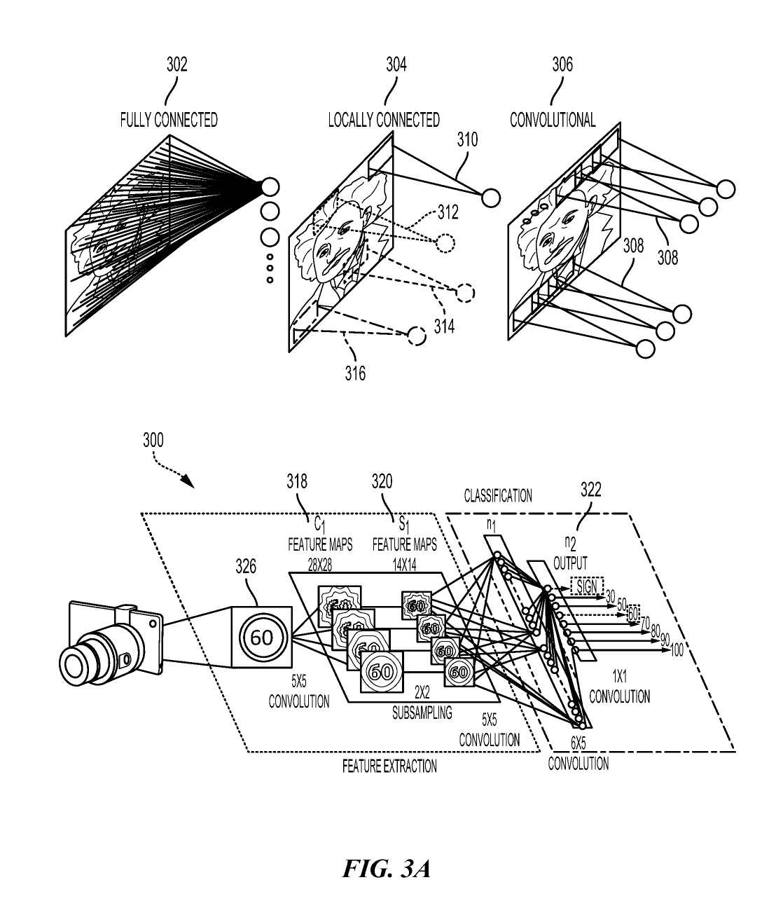

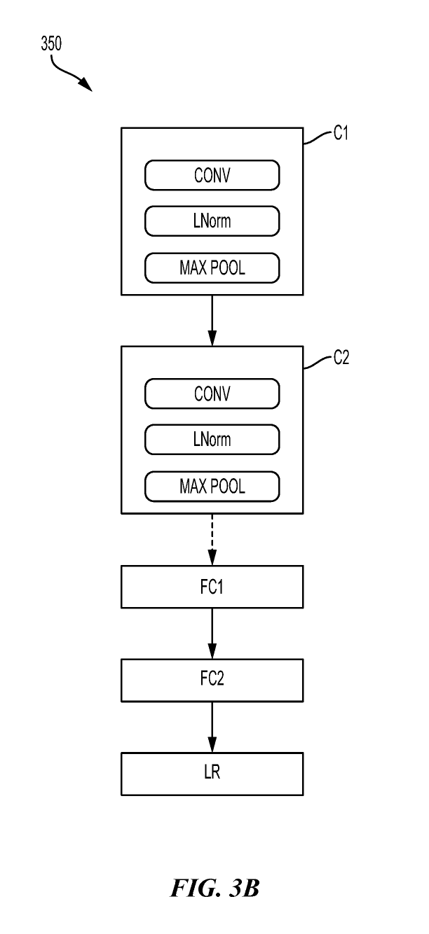

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A Deep Convolutional Network (DCN) may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

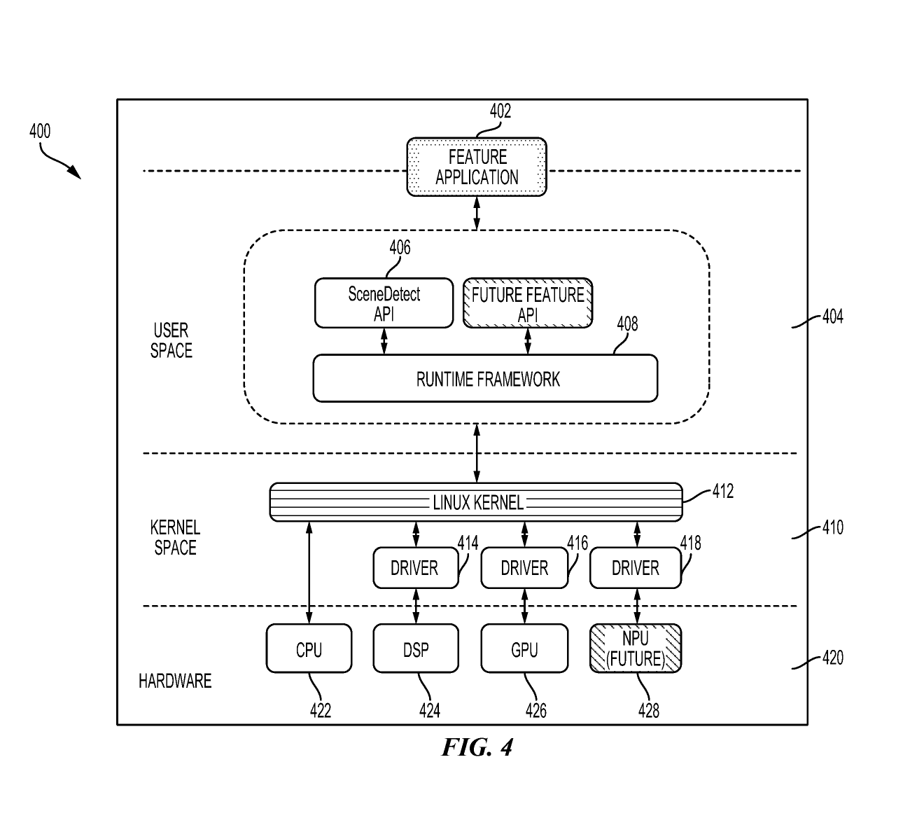

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

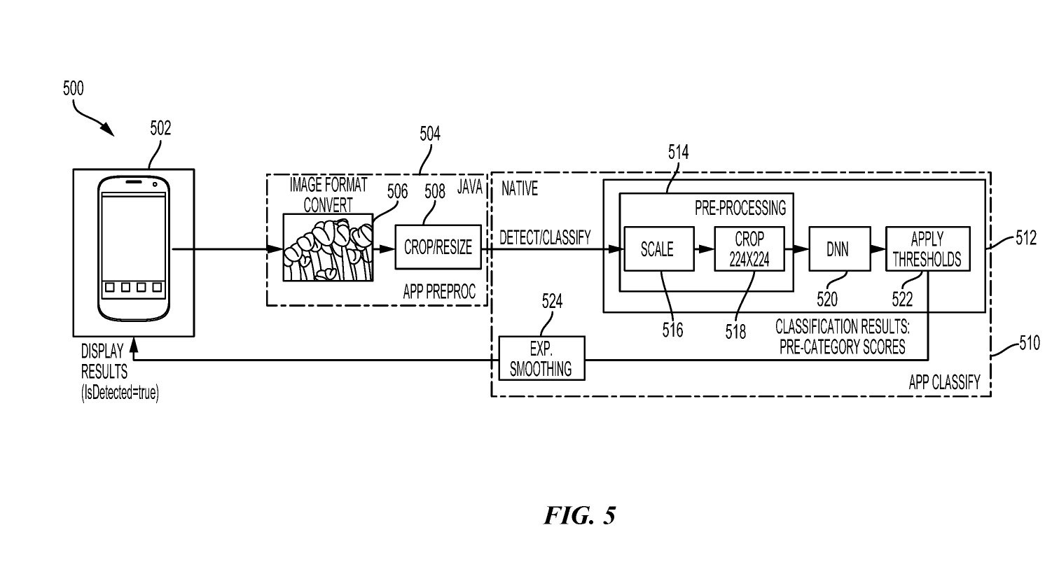

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

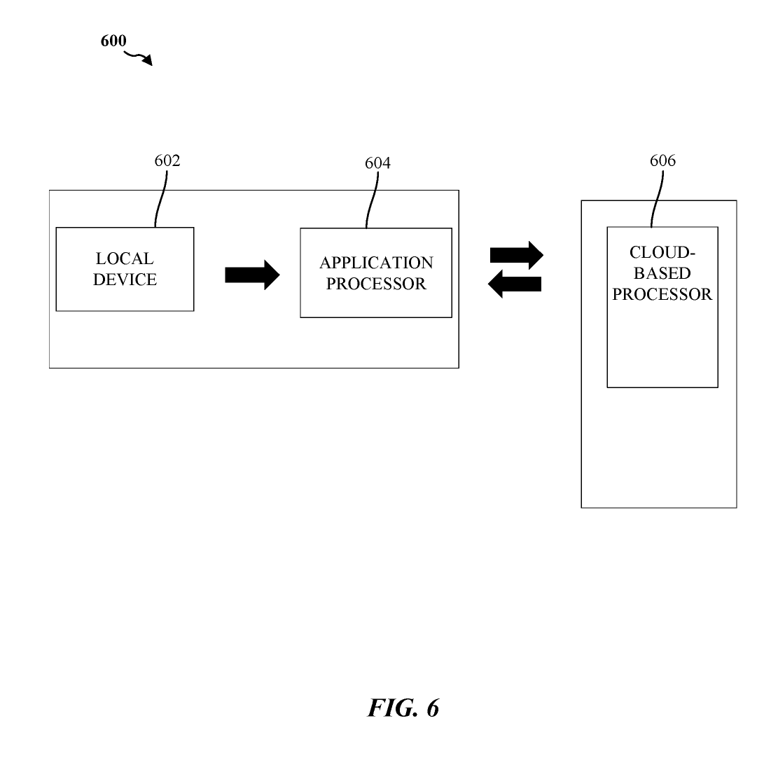

FIGS. 6-8 are block diagrams visually illustrating a process flow for cloud-based processing in accordance with aspects of the present disclosure. FIG. 6 is a block diagram 600 illustrating a system for cloud-based processing in accordance with aspects of the present disclosure. Referring to FIG. 6, a local device 602 may be configured to provide information or a package of information to a remote processor or cloud-based processor 606 for processing. The local device 602 may comprise a multimedia device such as a mobile phone (e.g., smartphone), a camera, audio device or the like. The local device 602 may be configured with a processor, such as a digital signal processor (DSP), for example. The DSP may, in some aspects, be coupled to or included within one or more sensors. The sensors, which may for instance comprise audio sensors (e.g., microphones), visual sensors (e.g., cameras) and/or other types of sensors, may detect environmental conditions.

The local device 602 may gather sensor information, which may include the raw sensor data from each of the sensors and related information (e.g., timestamp and location), and produce a package of information. The package may include, for example, raw sensor data, labels, user device identification and other information. The labels may be based on information available only to the local device 602, such as microphone location, speed, and device location. In some aspects, the labels may be based on device geometry, separated beamformed streams, device identification and/or the like.

The package of information may be supplied to an application processor (AP) 604 or other processor. The AP 604 may be external to the local device 602 or may be included within the local device 602. In some aspects, the AP 604 may be used to operate a local neural network. The AP 604 may compute classification outputs such as direction of arrival (DOA) labels based on sensor data from multiple microphones. The AP 604 may also handle interactions with the cloud-based processor 606 and in some cases update local device classifiers. In addition, the application processor 604 may further send the package to a remote or cloud-based processor 606.

The cloud-based processor 606 may be configured to compute classification outputs. The cloud-based processor 606 may also store the package and may use the package to train a neural network model based on the local device labels and/or device identification information. In some aspects, the cloud-based processor 606 may also compute updates for large-scale classifiers. Further, the cloud-based processor 606 may also transmit the classifier update to the local device 602 to improve classification performance on the local device 602.

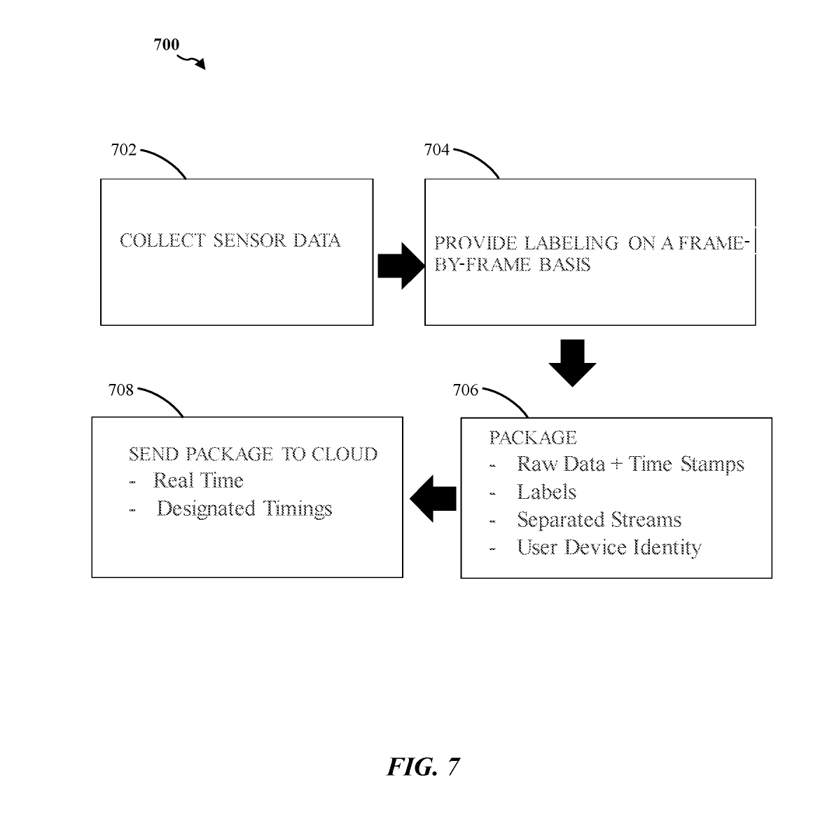

FIG. 7 is a block diagram 700 illustrating an example of local device processing (shown in FIG. 6) in accordance with aspects of the present disclosure. As shown in FIG. 7, in block 702, raw sensor data may be collected and in some aspects, the sensor data may be recorded. The raw sensor data may be collected via multiple sensors of the local device. For example, the raw sensor data may be recorded using a multi-microphone audio device associated with the local device or other sensor device (e.g., camera).

In block 704, the local device may provide labeling on a frame-by-frame basis. The labels may comprise direction of arrival (DOA) or foreground/background information based on the sensor data. The local device may also provide labels with additional metadata such as environmental information or configuration information. For example, in some aspects, the environmental information may include information regarding the use of air-conditioning or an air-conditioning setting. The configuration information may include accelerometer sensor output (e.g., a phone's orientation (sideways, upside down, etc.), miles per hour at which the device is travelling, a maximum number of directions of arrival for the device, and/or operating mode (e.g., handset mode, speaker mode, hands-free mode). The configuration information may also include device function information. For example, the device may be configured as an Internet Protocol (IP) camera. Such function or use case information may inform or affect the complexity of the labels. In some aspects, the number and/or location of sensors of the local device may vary based on the device identity (e.g., smart phone model), mode of operation and/or device function.

In some aspects, the local device may also determine separated beamformed streams based on the DOA information. The local device may also provide separated foreground and background streams. The separated beamformed streams may be provided on a frame-by-frame basis.

In block 706, the local device may retrieve the raw sensor data, labels, and device identification. The local device may also retrieve time stamps related to the collected raw sensor data. In some aspects, the retrieved information may be assembled as a package.

In block 708, the local device may send the package or retrieved information to a cloud-based processor (e.g., a cloud-computing device or server) for further processing. In some aspects, the package or retrieved information may be supplied in real time. In other aspects, the package or retrieved information may be supplied at designated time periods. For instance, the package or retrieved information may be sent at the end of a sensor measurement (e.g., when recording event using the multi-microphone audio device stops), during periods of lower network congestion or when local device processing activity is lower (e.g., at night when local device is charging).

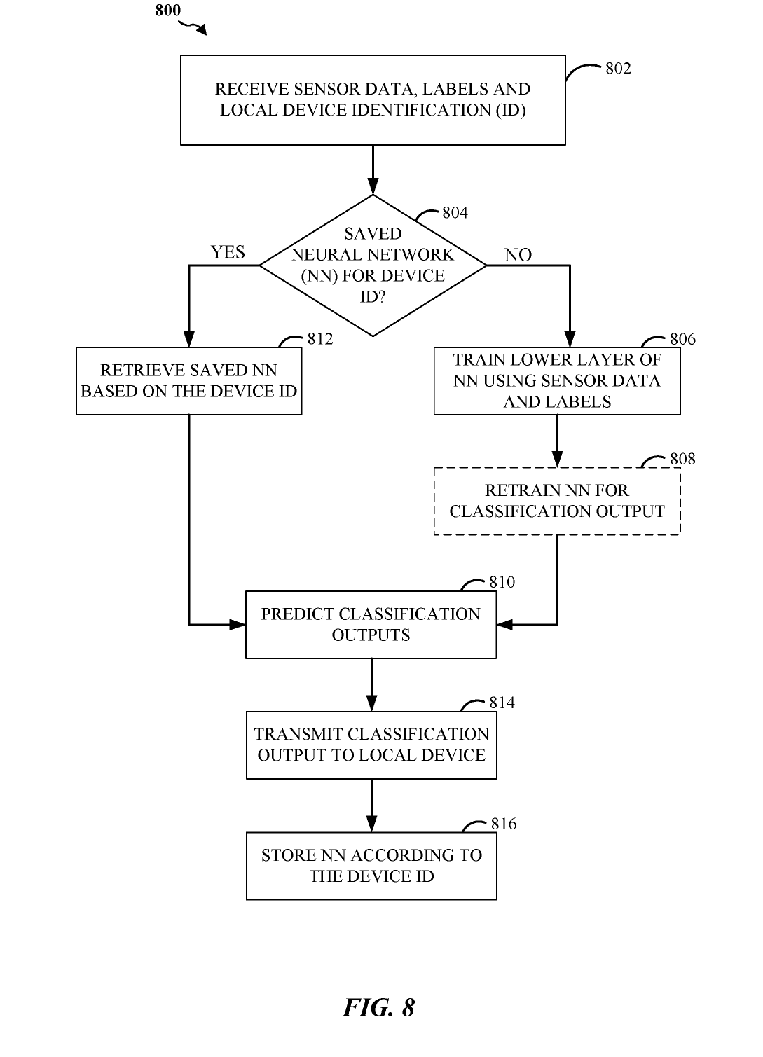

FIG. 8 is a block diagram illustrating an example method 800 of cloud-based processing. Referring to FIG. 8, in block 802, the cloud-based processor receives sensor data, labels and local device identification information from the local device. In some aspects, the cloud-based processor may also receive time stamps corresponding to the sensor data. Further, the cloud-based processor may also receive separated beamformed streams and/or foreground/background streams.

In block 804, the process determines if there is a saved neural network for the local device based on the local device identification information. In some aspects, the process may determine a saved neural network based on configuration information of the local device. For example, the process may determine a saved neural network based on a maximum number of DOAs and other metadata.

If there is no saved neural network appropriate for processing the received data (e.g., determining a classification output), in block 806, the process may train one or more of the lower layers of the neural network (e.g., a first convolutional layer (convl1)) using the sensor data and received labels. Using, the labels (e.g., DOA labels) as output (or training data) of the top layer of the neural network and the sensor data as the input to the neural network, the convolutional filter coefficients of the lower layer may be learned. For example, the convolutional filters may be trained to perform beamforming. The lower layer of the neural network (e.g., the convolutional filters of the first convolutional layer) may be incorporated into a neural network for classification of the sensor data.

In some aspects, the neural network including the trained lower layers may be retrained for a classification task. For example, the trained beamforming filters may be incorporated into a neural network for audio recognition. The neural network for audio recognition may be trained using audio event labels as the output and the sensor data as input. As such, the audio recognition neural network may learn the beamforming in combination with the audio recognition. In block 810, the process may retrain the neural network to predict a classification output based on the sensor data.

On the other hand, if there is a saved neural network for the device identification, in block 812, the process retrieves the saved neural network. For example, where the filter coefficients to model beamforming at the lower layers of the neural network are known for the particular device identification and have been previously stored, the coefficients may be retrieved. The process may then predict a classification output, in block 810, based on the sensor data without training or retraining the neural network.

In one example, if the local device (device identification) is known to the cloud service (cloud-based processor) and the device is being used in the same user mode as a previous cloud service interaction (phones for example can be used in a handset mode, speakerphone mode, and desktop mode), then the neural network may be operated without retraining because the spatial setup is the same. If, for example, a phone management service can receive data from many different types of devices (phones, cars, smart speakers, and the like, each having a different number and spatial arrangement of microphones (mics)), the user mode/device identification may be tracked. Accordingly, the cloud service (e.g., cloud-based processor) may determine whether the spatial information it has previously used for training the neural network is still valid. If the spatial information remains valid, the corresponding previously trained neural network (e.g., convolutional filter coefficients) may be retrieved and used to operate the neural network and predict a classification output (audio event) without retraining the neural network. In this way, the system resources may be preserved and computational efficiency may be achieved.

In block 814, the process may transmit the predicted classification output to the local device. In block 816, the process may store the neural network according to the identification of the local device.

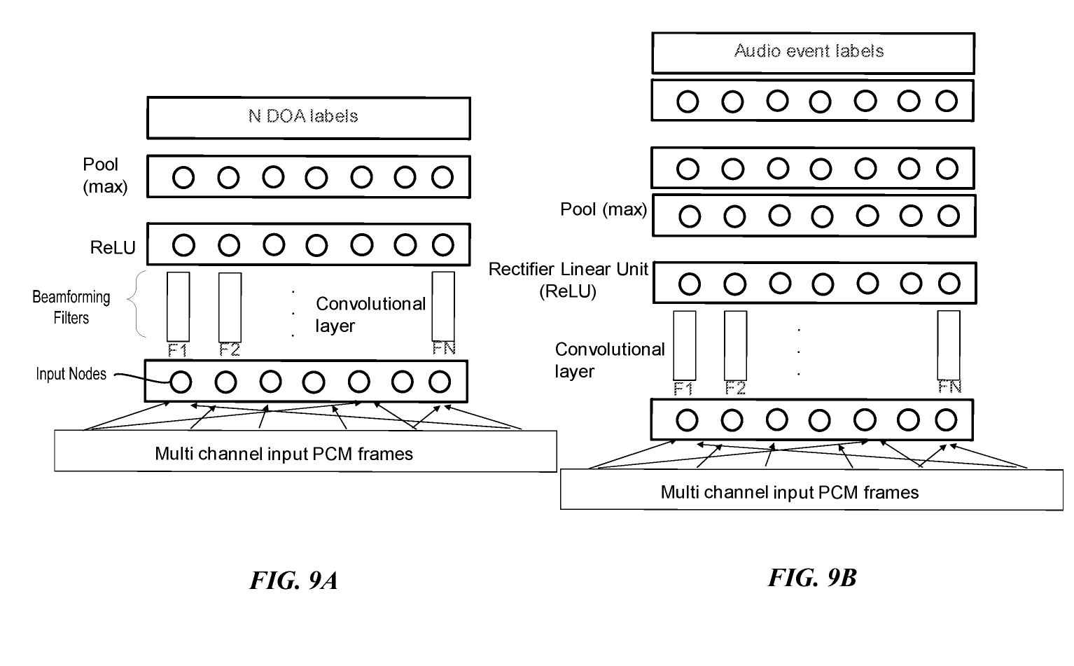

FIGS. 9A-B are block diagrams illustrating examples of training of the convolutional neural network in accordance with aspects of the present disclosure. A remote or cloud computing device may utilize labels and sensor data from a local device to train the cloud computing device for improved classification performance. By way of example, but not limitation, FIGS. 9A-B illustrate training using sensed audio data and labels for audio event classification. However, this is merely for ease of understanding and other types of sensor data may be used to train the neural network that may be used to perform other classification tasks.

Referring to FIG. 9A, multi-channel input pulse code modulation (PCM) frames are provided as inputs at a lower layer of a convolutional neural network (CNN). In the example of FIG. 9A, sensor data from seven microphone inputs, such as in a circular array, are supplied as inputs to the input nodes in an all-to-all connection manner. The inputs may comprise time domain signals. In some aspects, each microphone has an input node. The CNN includes a convolutional layer. In the convolutional layer, a convolutional filter (e.g., F1, F2, . . . , FN) is applied to each of the input nodes.

The CNN may be trained using conventional training techniques to learn the weights (or coefficients) of the convolutional filters. In one exemplary aspect, the received spatial information labels (e.g., DOA labels) computed on the local device may be used to train the convolutional filters. In this example, the spatial information labels (e.g., DOA labels) may be used as an output or training data and the sensor data (e.g., via multiple microphones) may be used as an input. Each path between the input nodes and the rectifier linear unit (ReLU) corresponds to a beamformer output. As such, if the corresponding direction of arrival (DOA) is known for the particular frame of data, the labels provided by a local device may be used as training labels to map each recording (sensor data) to a particular DOA. Examples of the labels include 0 degrees, 30 degrees, 60 degrees, 90 degrees, 120 degrees, 150 degrees and 180 degrees. The learned filters may implement narrow bandwidth beamformers, e.g., focused at 30 degree intervals. As such, the cloud-based processor may be configured to estimate the location of a source.

As shown in FIG. 9B, having trained the lower layers of the neural network (e.g., a first convolutional layer) to consider multi-sensor data (e.g., multi-microphone data with DOA labels), the DOA labels may be removed. The trained lower layers of the neural network (e.g., learned filters of the convolutional layer) may be included below a conventional speech recognition (phoneme) classification network such that each beamformer output is provided as an input to the conventional classification network and may be used to predict audio event labels. In some aspects, the speech recognition network including the trained lower layers may be trained to perform the speech recognition. For example, the coefficients of the trained convolutional filters may be held fixed. Using an audio event-training label as output and the received sensor data as input, the remaining layers of the speech recognition network may be trained. In this way, the speech recognition network may be trained to perform beamforming in combination with speech or audio recognition.

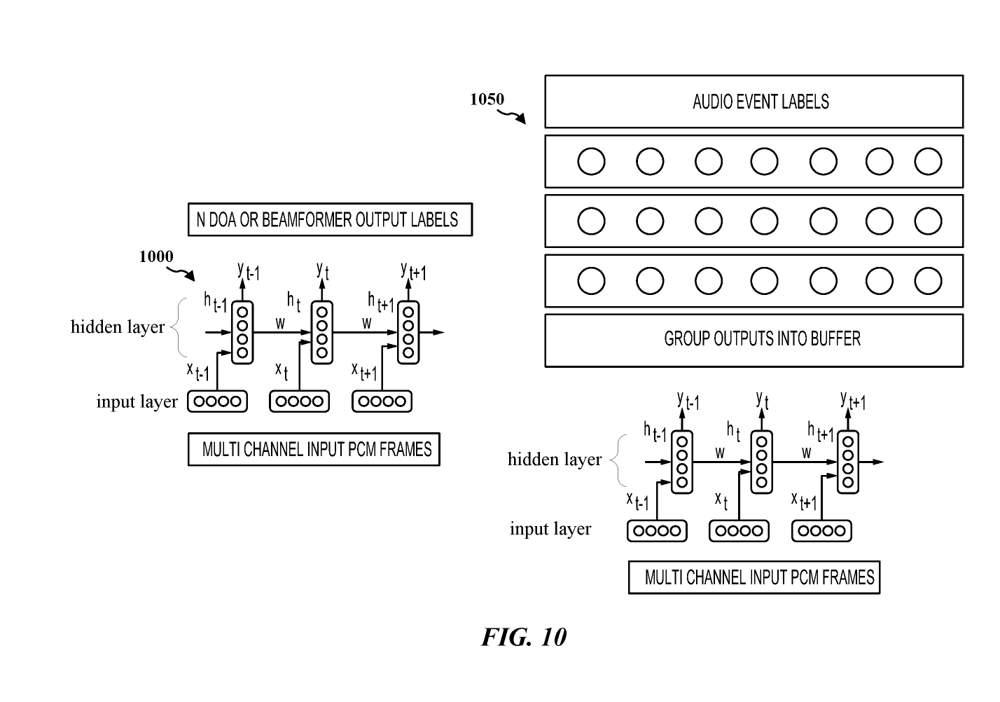

FIG. 10 illustrates an implementation using a recurrent neural network (e.g., long short-term memory (LSTM)) for processing on the cloud-based processor in accordance with aspects of the present disclosure. As shown in FIG. 10, the LSTM 1000 may be trained in a first phase using local labels, for example. During the training phase, the LSTM may receive inputs such from multi-channel input PCM frames, for instance. The time input steps (e.g., xₜ₋₁, xₜ, xₜ₊₁) are supplied to an input layer the LSTM 1000. The input at each time step t may include, for example, seven microphone time domain pulse code modulation (PCM) samples acquired over a certain period (only four input nodes are shown in FIG. 10 for ease of illustration). For each time frame, a hidden state may be determine at each of the hidden layer units (e.g., hₜ₋₁, hₜ, hₜ₊₁) and may be used to predict an output (e.g., yₜ₋ᵢ, yₜ, yₜ₊₁). In some aspects, the output yₜ may be given by yₜ=w*xₜ. During the training phase the outputs may be known or given and used to learn the weights (e.g., w, where w may comprise a weight matrix) of the hidden layer. The weights w determined at prior hidden layer units (e.g., hₜ) may be supplied to a subsequent hidden layer unit (e.g., hₜ₊₁) and used to compute the state of the subsequent hidden layer and to predict the output at the corresponding subsequent time step (e.g., yₜ₊₁). In some aspects, the layers of the LSTM may be trained/updated in relation to multi-mic processing. The outputs may comprise the direction of arrival (DOA) or beamforming time step outputs obtained by alternative beamforming designs as training labels. As such, during the training phase the LSTM may learn a beamformer. The LSTM 1000, whose architecture is, for example, defined by several layers of uni- or bi-directional LSTM units, may then be trained using these input time steps (e.g., xₜ) and corresponding training labels (e.g., N DOA or beamformer output labels) spanning the time range of the training data. The final trained LSTM 1000 may predict the DOAs or beamformed outputs corresponding to the multi-microphone inputs. As such, the trained LSTM 1000 may effectively mimic a beamforming operation itself (which can be nonlinear) and produce spatially discriminative outputs at different output nodes.

During the second or operational phase, the training labels (e.g. DOA or Beamformer label layer) may be removed. The trained LSTM 1000 may be included in a second neural network 1050, which may for instance comprise a convolutional neural network, a DCN, or other neural network. The second neural network 1050 may be larger (e.g., have additional layers) or more featured ((e.g., more processing capabilities and/or memory capacity) than the trained (first) LSTM. Additionally, during the second phase, an event layer (e.g., an audio event target layer including audio event labels as shown in FIG. 10) may then be used to train a second neural network including the trained LSTM. Using the input data and the given event training labels, the second neural network 1050 may be trained to recognize the events (e.g., audio events) in the training data (e.g., audio event labels).

In one example, the trained LSTM 1000, which is included in the second neural network 1050, may receive multichannel input PCM frames (e.g., xₜ₋₁, xₜ, xₜ₊₁). The inputs may be supplied to hidden layer units (e.g., e.g., hₜ₋₁, hₜ, hₜ₊₁) the weights w may be applied and used to determine a hidden state at each time step. The hidden state may in turn be used to predict an output (e.g., yₜ₋₁, yₜ, yₜ₊₁). Each of the outputs may comprise a multi-dimensional vector corresponding to the DOA label, for example. The outputs yₜ (e.g., DOA labels) may be supplied to the upper layers of the second neural network 1050. The additional layers of the second neural network 1050 may in turn be used to interpret the outputs of the trained LSTM 1000. As shown in FIG. 10, the outputs may be grouped into a buffer. Of course this is merely exemplary and other layers, such as a max pooling layer may also be used, for example. In the buffer layer, a maximum or highest output (e.g., energy) may be determined (e.g., at each time step). In some aspects, the highest output may be passed to subsequent layers of the neural network for further processing and the other outputs may be discarded). The highest output at each time step may be deemed the output label (e.g., beamforming direction). This highest output labels may then be propagated to the upper layers of the neural network and used to predict an event label (e.g., an audio event).

In one configuration, a machine learning model is configured for receiving sensor data captured from multiple sensors at a local device. The model is also configured for receiving spatial information labels computed on the local device using local configuration information. In addition, the model is configured for training lower layers of a first neural network based on the spatial information labels and sensor data. Further, the model is configured for incorporating the trained lower layers into a second, larger neural network for audio classification. Furthermore, the model is configured for retraining the larger neural network using the trained lower layers of the first neural network. The model includes means for receiving sensor data, means for receiving spatial information labels, training means, incorporating means, and/or retraining means. In one aspect, means for receiving sensor data, means for receiving spatial information labels, training means, incorporating means, and/or retraining means may be the general-purpose processor 102, program memory associated with the general-purpose processor 102, memory block 118, local processing units 202, and or the routing connection processing units 216 configured to perform the functions recited.

In another configuration, a machine learning model is configured for receiving device identification information of a local device and sensor data captured from multiple sensors at the local device. The model is also configured for setting convolutional filters of the neural network based on the device identification information. Further, the model is configured for predicting an audio event classification based on the sensor data without retraining the neural network. The model includes receiving means, setting means, and/or predicting means. In one aspect, the receiving means, setting means, and/or predicting means may be the general-purpose processor 102, program memory associated with the general-purpose processor 102, memory block 118, local processing units 202, and or the routing connection processing units 216 configured to perform the functions recited.

In yet another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

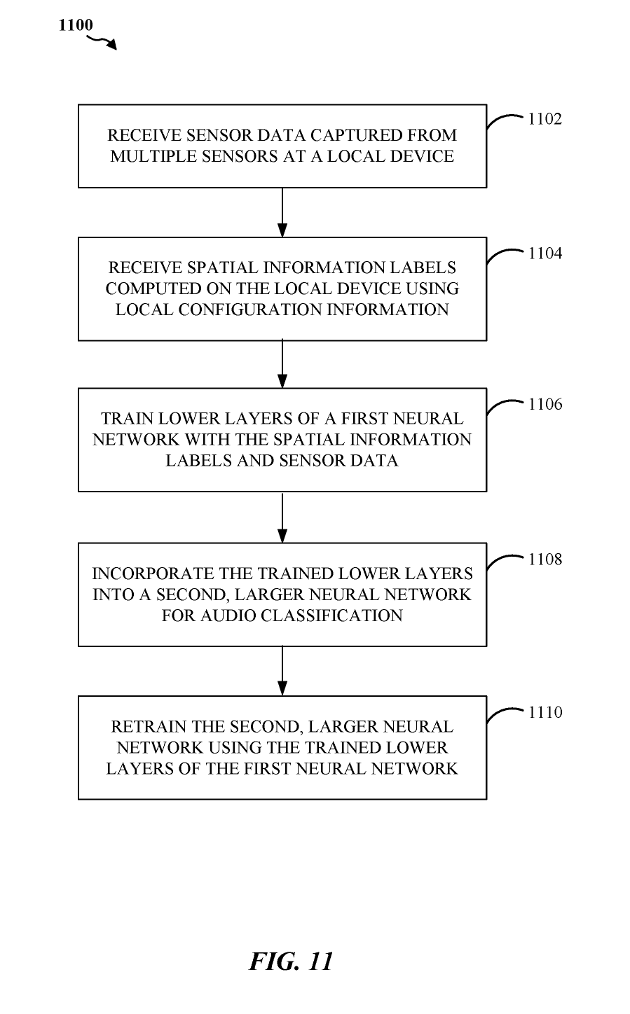

FIG. 11 illustrates a method 1100 for training a device-specific cloud-based audio processing artificial neural network. In block 1102, the process receives sensor data captured from multiple sensors at a local device.

In block 1104, the process receives spatial information labels computed on the local device using local configuration information. The spatial information labels are associated with the captured sensor data. The spatial information labels may, in some exemplary aspects, comprise the local device sensor geometry, direction of arrival information, foreground background separation information, locally computed beamforming output (e.g., beamformed streams) and the like.

In block 1106, the process trains lower layers of a first neural network with the spatial information labels and sensor data. In some aspects, the lower layers may comprise one or more convolutional layers. In block 1108, the process incorporates the trained lower layers into a second neural network for audio classification. In some aspects, the second neural network may be larger or include more features (e.g., increased processing capabilities or memory capacity) than the first neural network.

In block 1110, the process retrains the second, larger neural network using the trained lower layers of the first neural network. The retraining may include retraining only the second neural network or retraining the first neural network and the second neural network.

In some aspects, the process may receive the coefficients for beamforming filters from a local device for integration into a convolutional neural network. In this way, the process may enable more efficient and accurate source separation.

In some aspects, the process may further include separating beamformed streams from the sensor data based on the labels. Furthermore, the audio classification may be based on the beamformed streams.

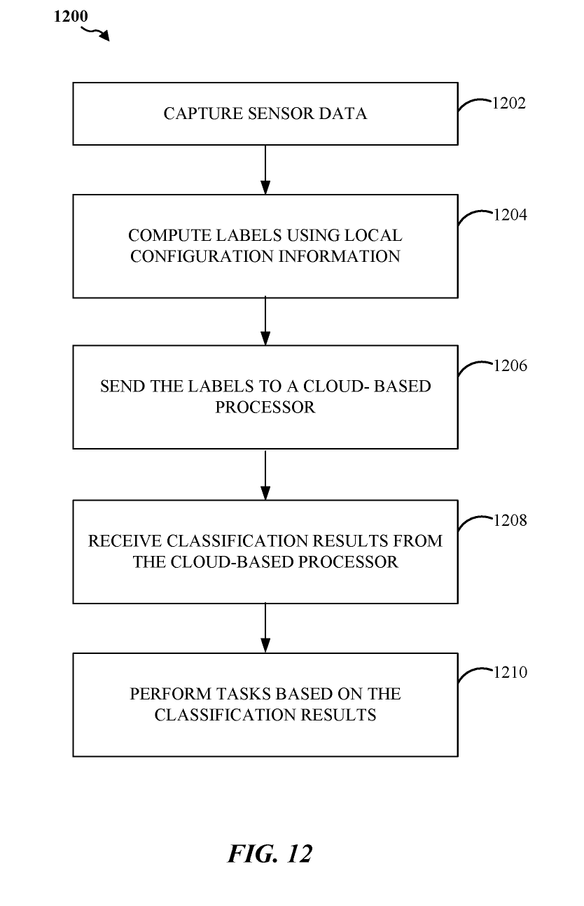

FIG. 12 is a block diagram illustrating a method 1200 for cloud-based multimedia processing. In block 1202, the process captures sensor data. In block 1204, the process computes labels using local configuration information. The labels are associated with the captured sensor data. In some aspects, the labels may comprise sensor geometry information, direction of arrival information, foreground background separation information, locally computed beamforming output (e.g., beamformed streams) and the like. In some aspects, the labels may be computed by separating beamformed streams from captured data. The beamformed streams may be used as labels for the captured data.

In block 1206, the process sends the labels to a cloud-based processor. In block 1208, the process receives classification results from the cloud-based processor. In block 1210, the process performs tasks based on the classification results.

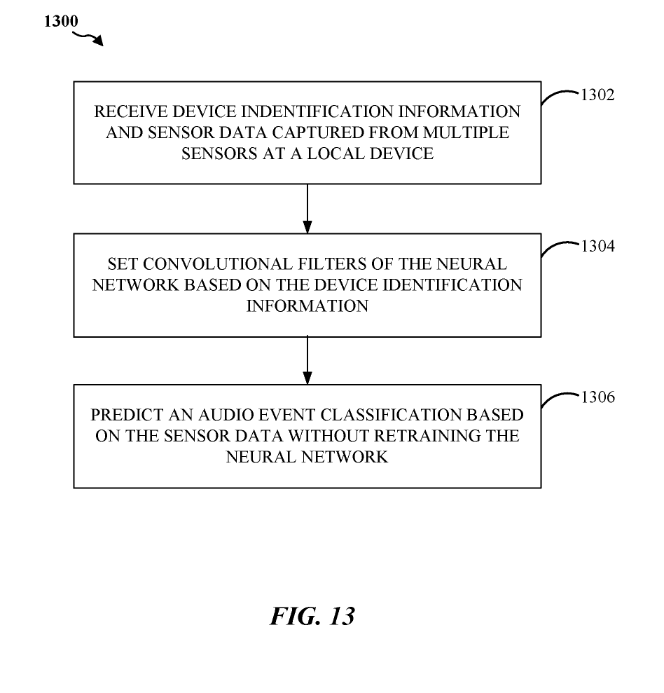

FIG. 13 is a block diagram illustrating a method 1300 for cloud-based multimedia processing. In block 1302, the process receives device identification information of a local device and sensor data captured from multiple sensors at the local device. In block 1304, the process sets convolutional filters of the neural network based on the device identification information. Furthermore, in block 1306, the process predicts an audio event classification based on the sensor data without retraining the neural network.

In some aspects, the process may also receive beamforming filters of the local device. In this aspect, rather than training or retraining the neural network as described above (with reference to FIG. 11), the process may replace convolutional filters of the neural network with the received beamforming filters without retraining the neural network.

In some aspects, the methods 800, 1100, 1200, and 1300 may be performed by the SOC 100 (FIG. 1) or the system 200 (FIG. 2). That is, each of the elements of the methods 800, 1100, 1200, and 1300 may, for example, but without limitation, be performed by the SOC 100 or the system 200 or one or more processors (e.g., CPU 102 and local processing unit 202) and/or other components included therein. In some aspects, the method 800, 1100, 1200, and 1300 may be performed by the SOC 420 (FIG. 4) or one or more processors (e.g., CPU 422) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of training a device specific cloud-based audio processor, comprising:
receiving sensor data captured from multiple sensors at a local device;
receiving spatial information labels computed on the local device using local configuration information, the spatial information labels associated with the captured sensor data;
training lower layers of a first neural network based on the spatial information labels and sensor data;
incorporating the trained lower layers into a second neural network for audio classification; and
retraining the second neural network using the trained lower layers of the first neural network.

2. The method of claim 1, in which retraining comprises retraining the first neural network and the second neural network.

3. The method of claim 1, in which retraining comprises retraining only the second neural network.

4. The method of claim 1, further comprising separating beamformed streams from the sensor data based on the spatial information labels.

5. The method of claim 4, further comprising classifying the sensor data based on the beamformed streams.

6. The method of claim 1, in which the spatial information labels comprise direction of arrival labels.

7. A method of cloud-based audio processing using an artificial neural network, comprising:
receiving device identification information of a local device and sensor data captured from multiple sensors at the local device;
setting convolutional filters of the neural network based on the device identification information; and
predicting an audio event classification based on the sensor data without retraining the neural network.

8. The method of claim 7, further comprising:
receiving beamforming filters of the local device; and
replacing the convolutional filters of the neural network with the received beamforming filters without retraining the neural network.

9. An apparatus for training a device specific cloud-based audio processor, comprising:
a memory; and
at least one processor coupled to the memory, the at least one processor configured:
to receive sensor data captured from multiple sensors at a local device;
to receive spatial information labels computed on the local device using local configuration information, the spatial information labels associated with the captured sensor data;
to train lower layers of a first neural network based on the spatial information labels and sensor data;
to incorporate the trained lower layers into a second neural network for audio classification; and
to retrain the second neural network using the trained lower layers of the first neural network.

10. The apparatus of claim 9, in which the at least one processor is further configured to retrain the first neural network and the second neural network.

11. The apparatus of claim 9, in which the at least one processor is further configured to retrain only the second neural network.

12. The apparatus of claim 9, in which the at least one processor is further configured to separate beamformed streams from the sensor data based on the spatial information labels.

13. The apparatus of claim 12, in which the at least one processor is further configured to classify the sensor data based on the beamformed streams.

14. The apparatus of claim 9, in which the spatial information labels comprise direction of arrival labels.

15. An apparatus for training a device specific cloud-based audio processor, comprising:
means for receiving sensor data captured from multiple sensors at a local device;
means for receiving spatial information labels computed on the local device using local configuration information, the spatial information labels associated with the captured sensor data;
means for training lower layers of a first neural network based on the spatial information labels and sensor data;
means for incorporating the trained lower layers into a second neural network for audio classification; and
means for retraining the second neural network using the trained lower layers of the first neural network.

16. The apparatus of claim 15, in which the means for retraining retrains the first neural network and the second neural network.

17. The apparatus of claim 15, in which the means for retraining retrains only the second neural network.

18. The apparatus of claim 15, further comprising means for separating beamformed streams from the sensor data based on the spatial information labels.

19. The apparatus of claim 18, further comprising means for classifying the sensor data based on the beamformed streams.

20. The apparatus of claim 15, in which the spatial information labels comprise direction of arrival labels.
